(19) United States
(12) Patent Application Publication
(10) Pub. No.: US 2025/0023599 A1
(43) Pub. Date: Jan. 16, 2025

(54) MULTIPLEXER TRANSFORMER

(71) Applicant: Forefront RF Ltd, Cambridge (GB)

(72) Inventors: Leo Laughlin, Cambridge (GB); Michael Guess, Cambridge (GB)

(21) Appl. No.: 18/714,274

(22) PCT Filed: Nov. 29, 2022
(86) PCT No.: PCT/EP2022/083726

§ 371 Date: May 29, 2024

(30) Foreign Application Priority Data
Nov. 29, 2021 (GB) 2117221.8

(51) Int. Cl. H04B 1/525; H04B 1/00

(52) U.S. Cl. CPC H04B 1/525; H04B 1/0057

(57) ABSTRACT

There is disclosed a multiplexer comprising: a first port; a second port; a third port connected to the first port and the second port; a fourth port connected to the first port and the second port; and a transformer connected at the first port, and having a first winding connected between the first port and one of the third and fourth ports and a second winding connected to the other of the third and fourth ports and electrical ground, wherein one of the first to fourth ports is for connection to an antenna, the multiplexer further comprising: a transmit filter connected between the port for connection to the antenna and one of ports to which that port is connected; and a receive filter connected between the port for connection to the antenna and the other of the ports. A cancellation circuit connected between the third and fourth ports, comprises a plurality of parallel channels between the second receive and transmit filters, each channel including a filter.

### FIELD OF THE INVENTION

The present invention is related to minimising the generation of self-interference and/or cancelling generated self-interference in a multiplexer in which a shared antenna is used to transmit and receive signals.

### BACKGROUND TO THE INVENTION

A feature of a duplexer is the ability to transmit and receive wireless signals at the same time using a shared antenna.

A known duplexer is implemented in a four-port network with transmit and receiver ports, an antenna port, and an impedance port. A balancing impedance is connected to the impedance port, to balance the impedance of the antenna.

Simultaneously transmitting and receiving wireless signals in a shared antenna of a duplexer leads to a problem where the relatively high-powered signal transmitted from the transmitter is coupled to the receiver, where it can provide an interference signal to obscure a relatively low-powered signal which is desired to be received. Thus, a duplexer arrangement is typically required to suppress interference at or before a receiver in order to enable successful reception in the presence of transmission at the shared antenna.

It is known to provide a canceller circuit in a duplexer to cancel such self-interference.

It is an object to provide an improved circuit arrangement for providing frequency isolation to reduce the occurrence of self-interference in a duplexer.

It is an object to provide an improved circuit arrangement for improved cancellation of self-interference that arises in a duplexer.

### STATEMENT OF THE INVENTION

A multiplexer is provided comprising, according to one aspect of the invention: a first port; a second port; a third port connected to the first port and the second port; a fourth port connected to the first port and the second port; and a transformer connected at the first port, and having a first winding connected between the first port and one of the third and fourth ports and a second winding connected to the other of the third and fourth ports and electrical ground, wherein one of the first to fourth ports is for connection to an antenna, the multiplexer further comprising: a transmit filter connected between the port for connection to the antenna and one of ports to which that port is connected; and a receive filter connected between the port for connection to the antenna and the other of the ports to which that port is connected.

When connected between the same ports, the first or second winding and the transmit or receive filters are preferably connected in series.

The multiplexer may further comprise: a further transmit filter connected between the port to which the port for connection to the antenna is not connected and one of the ports to which that port is connected; and a further receive filter connected between the port to which the port for connection to the antenna is not connected and the other of the ports to which that port is connected.

When connected between the same ports, the first or second winding and the first further or second further filter are preferably connected in series.

The multiplexer may be implemented as a three-port network.

One of the ports which is not connected to the port which is for connection to the antenna may comprise two terminals, the multiplexer further comprising a network in series connected between the two terminals, wherein the other two of the four ports are for connection of the transmit and receive signals of the multiplexer.

The first port may be for connection to the antenna, the second port comprises two network terminals, the network in series connected between the terminals of the second port, and the third and fourth ports are for connection of the transmit and receive signals of the multiplexer.

The first port may be for connection of a transmit signal of the multiplexer, the second port is for connection of a receive signal of the multiplexer, the network in series is connected between terminals of the third or fourth ports, and the other of the third or fourth ports is for connection to the antenna.

The first port may be for connection to a receive signal of the multiplexer, the second port is for connection to a transmit signal of the multiplexer, the network in series is connected between terminals of the third or fourth ports, and the other of the third or fourth ports is for connection to the antenna.

The multiplexer may be implemented as a four-port network.

One of the first to fourth ports which is not connected to the antenna or a port connected to the port which is not connected to the antenna may be for connection to an impedance.

The first port may be for connection to the antenna, the second port is for connection to the impedance, one of the third and fourth ports is a for connection of a transmit signal of the duplexer, and the other of the third and fourth ports is for connection of a receive signal of the duplexer.

The first port may be for connection of a transmit signal of the duplexer, the second port is for connection of a receive signal of the duplexer, one of the third and fourth ports is for connection to the antenna, and the other of the third and fourth ports is for connection to the impedance.

The first port may be for connection to an impedance, the second port is for connection to the antenna, one of the third and fourth ports is for connection of a transmit signal of the multiplexer, and the other of the third and fourth ports is for connection of a receiver signal of the multiplexer.

The first port may be for connection of a receive signal of the duplexer, the second port is for connection of a transmit signal of the duplexer, one of the third and fourth ports is for connection to the antenna, and the other of the third and fourth ports is for connection to the impedance.

The one of the first to fourth ports which is not connected to the antenna or a port connected to the port which is not connected to the antenna may comprise two terminals, the multiplexer further comprising a network in series connected between the two terminals.

There may be provided further transformers.

The multiplexer may further comprise a further transformer connected at the second port, having a further first winding connected between the third and fourth ports, and having a further second winding connected between the second port and electrical ground.

When connected between the same ports, the further first or further second winding and the transmit or receive filters may be connected in series.

When connected between the same ports, the further first or further second winding and the further transmit or further receive filters may be connected in series.

A canceller may be provided in the multiplexer to reduce or minimise self-interference.

The network connected in series between the two terminals may be configured to provide cancellation of self-interference in the duplexer.

The series network may comprise a plurality of parallel channels connected between the first and second terminals, each channel including a filter.

Each channel may further include an impedance connected in series with the filter.

Each channel may include a further filter connected in series with the filter and the impedance, each impedance being connected between the filter and the further filter in that channel.

The passband of each filter may be contiguous with the passband of a filter of another channel. The passband of the filter and further filter in each channel may be the same. Each frequency filter may be tuneable. Each impedance may be tuneable.

The transmit and receive filters may be second order filters, the further transmit and receive filters may be first order filters, and the filter in each channel may be a first order filter.

Each filter may have a passband tuned to the frequency of signals to be transmitted between the ports between which the filter is connected, and in this passband each filter presents a matched impedance to these signals.

A port of each filter connected to another filter may be configured to provide an impedance higher than a matched impedance in the passband of the other filter.

A port of each filter connected to a transformer may be configured to provide a lower impedance than a matched impedance in the passband of another filter connected to the transformer.

Known techniques of circuit design may be used to achieve the desired effect of lowering or raising the impedance.

The transmit signal of the multiplexer is an input signal of the multiplexer, to be transmitted from an antenna connected to the multiplexer. The receive signal of the multiplexer is an output signal of the multiplexer, to be received from an antenna connected to the multiplexer.

Where provided, the impedance may have a value to balance the impedance of an antenna connected to the duplexer. Where provided, the impedance may provide frequency isolation of signals between two ports of the multiplexer, e.g., a transmit and a receive port.

A multiplexer is provided comprising, according to another aspect of the invention: a first port for connection to an antenna, and for receiving signals at a transmit frequency and a receive frequency; a second port comprising first and second terminals; a third port for receiving a signal to be transmitted, and to connect signals at the transmit frequency to the first port and to connect signals to a terminal of the second port; a fourth port for receiving a signal received by the antenna, and to connect signals at the receive frequency to the first port and to connect signals to the other terminal of the second port; a transmit filter connected between the first port and the third port; a receive filter connected between the first port and the fourth port; and a cancellation circuit connected between the third and fourth ports, comprising a plurality of parallel channels between the second receive and transmit filters, each channel including a filter.

Each channel may further include an impedance connected in series with the filter.

Each channel may include a further filter connected in series with the filter and the further filter, each impedance being connected between the filter and the further filter in that channel.

The passband of each filter may be contiguous with the passband of a frequency filter of another channel. The passband of the filter and further filter in each channel is the same. Each frequency filter may be tuneable. Each impedance may be tuneable.

The multiplexer may further comprise: a further transmit filter connected between the second port and the fourth port, and a further receive filter connected between the second port and the third port.

The transmit and receive filters may be second order filters, the further transmit and receive filters may be first order filters, and the filter in each channel may be a second order filter.

The order of the transmit filter may be equal to the sum of the order of the further transmit filter and the order of one of the filters in each channel, and the order of the receive filter may be equal to the sum of the order of the further receive filter and the order of one of the further filters in each channel. Such an arrangement may be deployed in a canceller circuit in a three-port of four-port network.

The described transformer topology provides an improved circuit arrangement for providing frequency isolation to reduce the occurrence of self-interference in a multiplexer, such as in a duplexer.

The described canceller circuit provides an improved circuit arrangement for improving cancellation of self-interference that arises in a multiplexer, such as in a duplexer.

There may be provided a method for controlling any part of the circuitry.

There may be provided a computer program which when executed on a processor performs any part of the method.

There may be provided a computer program product for storing such code. The computer program product may be a non-transitory product.

### BRIEF DESCRIPTION OF THE FIGURES

The invention is now described with reference to the accompanying drawings, in which:

FIG. 1 illustrates a first exemplary four-port duplexer including two transformers;

FIG. 2 illustrates a second exemplary four-port duplexer including two transformers;

FIG. 3 illustrates a third exemplary four-port duplexer including two transformers;

FIG. 4 illustrates a first exemplary three-port duplexer including a transformer;

FIG. 5 illustrates a second exemplary three-port duplexer including a transformer and a canceller circuit;

FIG. 6 illustrates an exemplary filter for a duplexer according to any of FIGS. 1 to 5;

FIG. 7 illustrates a first exemplary sub-canceller circuit for a duplexer according to FIG. 5; and

FIG. 8 illustrates a second exemplary sub-canceller circuit for a duplexer according to FIG. 5.

### DESCRIPTION OF PREFERRED EMBODIMENTS

The invention is now described by way of reference to examples and embodiments.

An exemplary, but non-limiting, implementation of the apparatus described is in the front-end of an RF device, such as a mobile RF device, such as a mobile phone.

Example implementations are set out in the context of a duplexer. More generally the arrangements discussed apply to a multiplexer.

Some elements which are not essential, and which are not limiting, are shown in the figures for ease of explanation.

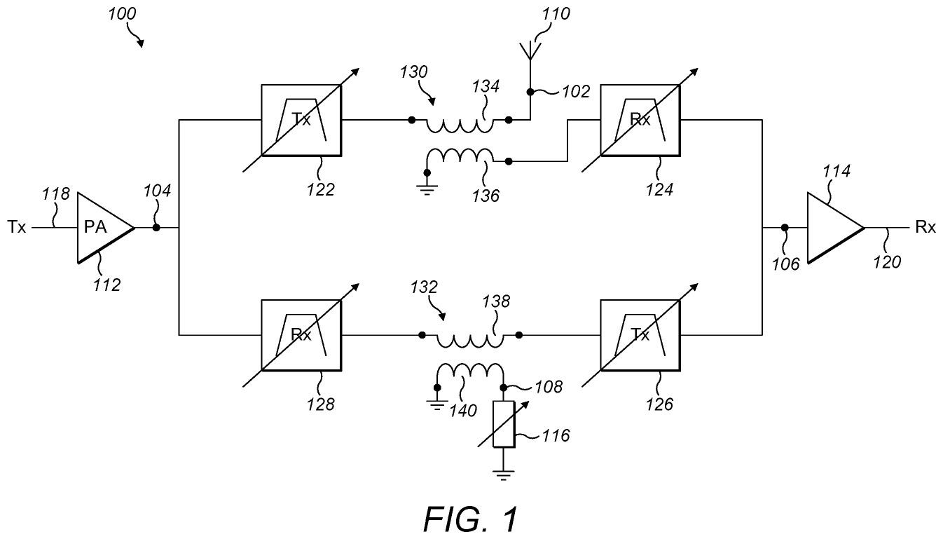

With reference to FIG. 1 there is illustrated a basic topology of an exemplary four-port duplexer 100 comprising a transmit port 104, a receive port 106, an antenna port 102 and an impedance port 108.

In the exemplary arrangement of FIG. 1 a transmit signal Tₓ on line 118 provides an input to a power amplifier (PA) 112, which delivers a signal to be transmitted to the transmit port 104. An antenna 110 is connected to the antenna port 102. A received signal on the receive port 106 provides an input to a low noise amplifier (LNA) 114 which delivers a receive signal Rx on line 120. A variable impedance 116 is connected between the impedance port 108 and electrical ground.

The exemplary duplexer 100 of FIG. 1 includes a first transmit filter 122, a first receive filter 124, a second transmit filter 126, a second receive filter 128, a first transformer 130, and a second transformer 132. The first transformer 130 comprises a first winding 134 and a second winding 136. The second transformer 132 comprises a first winding 138 and a second winding 140.

In the exemplary duplexer 100 of FIG. 1 the first transformer 130 is connected at the antenna port 102, and the further transformer 132 is connected at the impedance port 108.

The connection of the transformers is such that the transmit port 104 is preferably isolated from the (opposite) receiver port 106, and the antenna port 102 is preferably isolated from the (opposite) impedance port 108. In general, opposite ports in a four-port network are frequency isolated. By isolated, it is meant that the circuit is configured such that ports are intended to be isolated at the frequency of interest. In practice, leakage between the ports occurs, which results in self-interference in the duplexer as discussed below. Whilst it is important to maximise isolation between the opposite transmit and receive ports, isolation between the opposite antenna and impedance ports may not be so critical. Note that the ports are referred to as opposite to denote the desired isolation between them, and does not imply any physical arrangement.

The connection of the transformers is such that the transmit port is connected to the antenna and impedance ports, and the receiver port is connected to the antenna and impedance ports. The connections between these ports is preferably established at certain frequencies. The ports may be referred to as adjacent to denote the connection between them is established at certain frequencies, but this does not imply any physical arrangement.

In the exemplary duplexer 100 of FIG. 1 the first transmit filter 122 is connected between the transmit port 104 and the first transformer 130, and the first receive filter 124 is connected between the receive port 106 and the first transformer 130. More particularly the first winding 134 of the first transformer 130 is connected in series between the first transmit filter and the antenna port 102, and the second winding 136 of the transformer 130 is connected in series between the first receive filter 124 and electrical ground.

In the exemplary duplexer 100 of FIG. 1 the second transmit filter 126 is connected between the receive port 106 and the second transformer 132, and the second receive filter 124 is connected between the transmit port 104 and the second transformer 132. More particularly the first winding 138 of the second transformer 132 is connected in series between the second transmit filter 126 and the second receive filter 128, and the second winding 140 of the second transformer 132 is connected in series between the impedance port 108 and electrical ground.

The first transformer 130 inverts any component of the transmit signal Tx which leaks from the first winding 134 to the second winding 136, i.e. any signal which leaks from the transmit port 104 to the receive port 106 via the first transformer 130. In contrast, transmit signals coupled from the transmit port 104 to the antenna port 102 are not inverted, and receive signals coupled from the antenna port 102 to the receive port 106 are not inverted. Thus, the method of connection of the transformer 130 provides inversion for self-interference (leakage) signals in a path between the transmit port 104 and the receive port 106 without introducing an inversion into either the transmit or the receive signal paths. Achieving this signal coupling behaviour in the exemplary duplexer 100 requires a transformer 130 with first and second windings configured in the same polarity. Alternatively, first and second windings with opposite polarity could be used and the connections of the terminals of either the first or second winding could then be swapped to achieve the same result. The second transformer 132 has a series connection between the transmit and receive ports via transformer winding 138—therefore any signal which leaks from the transmit port 104 to the receive port 106 via the second transformer 132 is not inverted. In an ideal duplexer with ideal transformers, and where the transmit filters 122 and 126 have the same transfer functions, and where the receive filters 128 and 124 also have the same transfer functions, the inverted signal from the transformer 130 cancels the non-inverted signals from the transformer 132 at the transmit port 106 to cancel any self-interference at the receive port 106.

In general, it can be understood that one path between the transmit port and the receive port must invert leakage signals, and one must not, so that the two leakage signals cancel each other—in an ideal circuit—at the receiver port. For this cancellation to occur optimally, one path must preferably have a transfer function which is (ideally) equal in magnitude and opposite in phase compared to the other path, over the frequency band or bands of interest, e.g. a transmit frequency band and a receive frequency band. One path between the transmit and receive ports is via the antenna port, and one path between the transmit and receive ports is via the impedance port.

FIG. 1 represents an example implementation of a transformer (the first transformer 130). This transformer may be implemented at the transmit port, the receive port, the antenna port (as shown in FIG. 1), or the impedance port. A series connection must preferably be implemented in the opposite port. The transformer 132 (the second transformer) in FIG. 1 provides a series connection at the opposite port in the exemplary four-port network. This series connection ensures cancellation of self-interference between the transmit and receive ports.

Variants of a four-port network are discussed below.

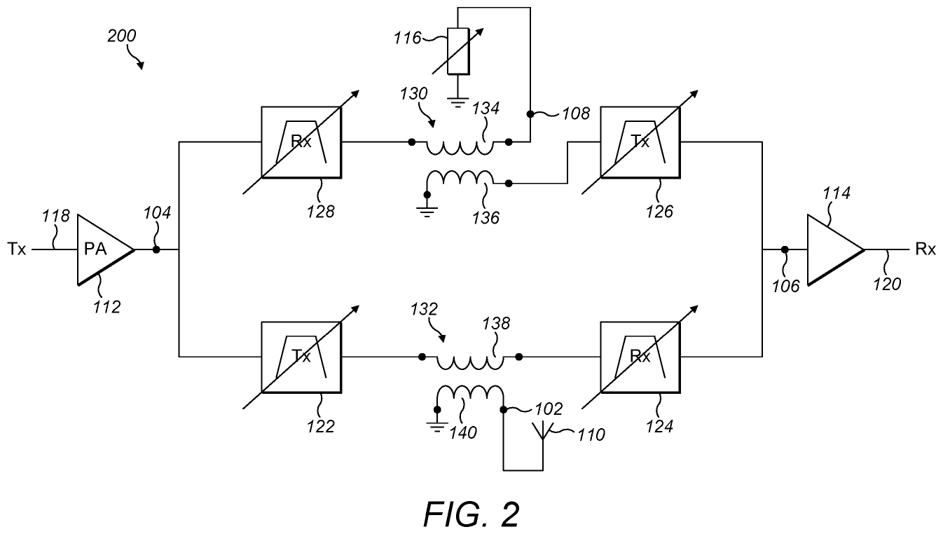

With reference to FIG. 2 there is shown an exemplary four-port duplexer 200 which is a variant of the exemplary four-port duplexer of FIG. 1. Where elements of FIG. 2 are the same as elements in FIG. 1 like reference numerals are used. All of the elements of the duplexer of FIG. 1 are used in the duplexer of FIG. 2, but they are interconnected differently.

In the exemplary duplexer 200 of FIG. 2 the transformer 130 is connected at the impedance port. The antenna port 102 and the impedance port 108 swap positions, so they are respectively connected to the second and first transformers 132 and 130. The filters are also swapped: the first transmit filter 122 is connected between the transmit port 104 and the second transformer 132, the first receive filter 124 is connected between the receive port 106 and the second transformer 132, the second transmit filter 126 is connected between the receive port 106 and the first transformer 130, and the second receiver filter 128 is connected between the transmit port 104 and the first transformer 130.

The exemplary four-port duplexer 200 operates with the same behaviour as the exemplary four-port duplexer 100.

In the duplexers 100 and 200 of FIGS. 1 and 2 the transformers are implemented at the antenna and impedance ports. Alternatively the transformers could be implemented at the transmit and receive ports.

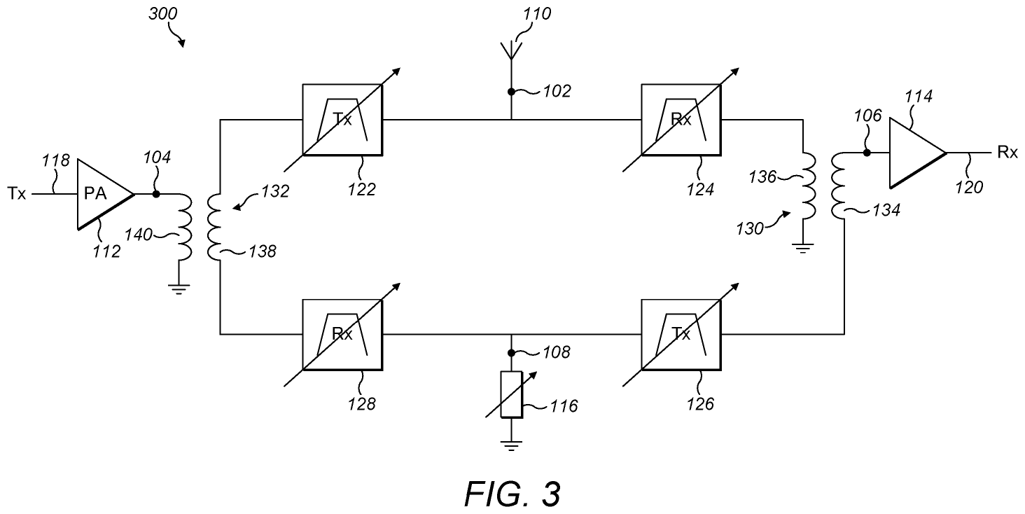

With reference to FIG. 3 there is shown an exemplary four-port duplexer 300 which is a variant of the exemplary duplexer of FIG. 1. The first transformer 130 is connected at the receive port. The transformer 132 is preferably connected at the transmit port.

Where elements of FIG. 3 are the same as elements in FIG. 1 like reference numerals are used. All of the elements of the duplexer of FIG. 1 are used in the duplexer of FIG. 3, but they are interconnected differently.

In the exemplary duplexer 300 of FIG. 3, the first winding 134 of the first transformer 130 is connected between the receive port 106 and the second transmit filter 126. The second winding 136 of the first transformer 130 is connected between the first receiver filter 124 and electrical ground. The first winding 138 of the first transformer 132 is connected between the second receiver filter 128 and the first transmit filter 122. The second winding 140 of the second transformer 132 is connected between the transmit port 104 and electrical ground. The antenna port 102 is connected between the first transmit and receiver filters 122 and 124. The impedance port is connected between the second transmit and receiver filters 126 and 128.

As with the variant of FIG. 2 from FIG. 1, there is a further variant of FIG. 3 in which the first transformer 130 is connected at the transmit port, and the second transformer is preferably connected to the receive port. The antenna and impedance ports are swapped, the first transmit filter and the second receiver filter are swapped, and the first receive filter and the second transmit filter are swapped.

In general, the examples of FIGS. 1 to 3 are of a four-port network with adjacent ports frequency-coupled, and opposite ports isolated. The opposite ports are the transmit and receive port pair, and the antenna and impedance port pair. The terms opposite and adjacent refer—throughout this description—to signal coupling behaviour, and not physical positioning.

The advantageous arrangement of the first transformer 130 is connected at any one of the ports of the four-port network. The second transformer 132 may be connected at an opposite port, but in general a series connection is implemented at the opposite port, and the second transformer is an example.

In the four-port network the impedance port connects to a variable impedance, which may be tuned so as to balance the impedance of the antenna connected to the antenna port.

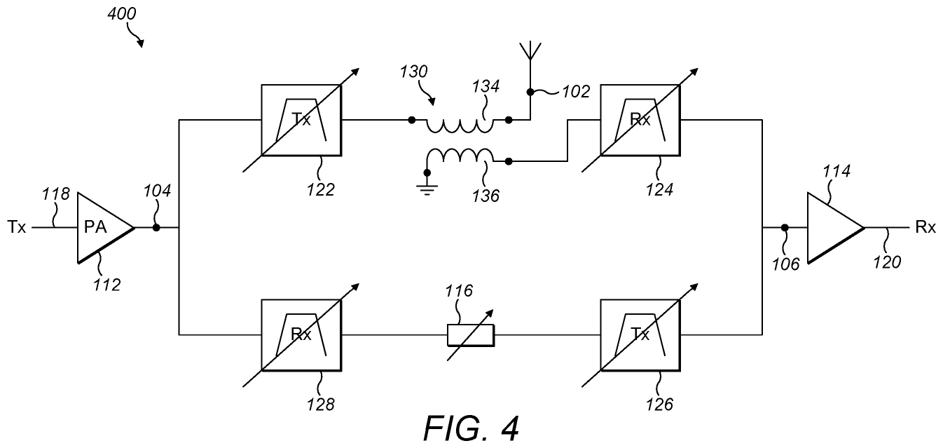

The topology of the first transformer 130 is not limited to implementation in a four-port network. This transformer topology may also be implemented in a three-port network. FIG. 4 illustrates an exemplary three-port network duplexer 400, utilising this transformer topology. Where elements of FIG. 4 are the same as elements in FIG. 1 like reference numerals are used.

In a three-port network only the first transformer 130 may be provided, and not the second transformer 132. The transformer topology 130 may be implemented at any one of the three ports. Any one of the three ports may be the antenna port, regardless of which port the transformer topology 130 is implemented at.

Variants of the FIG. 1 arrangement for three-port duplexers are set out below.

Comparing FIG. 4 with FIG. 1, it can be seen that the second transformer 132 is replaced by a series connection, in this example a variable impedance 116, directly connected between the second transmit filter 126 and the second receive filter 128. The impedance port 108 is not shown, as no connection to an external impedance is required. If the second transformer 132 of the duplexer 100 of FIG. 1 is an ideal transformer, then the duplexers of FIGS. 1 and 4 are equivalent, as the second transformer 132 of the duplexer 100 FIG. 1 has the effect of transforming the shunt impedance into a series impedance.

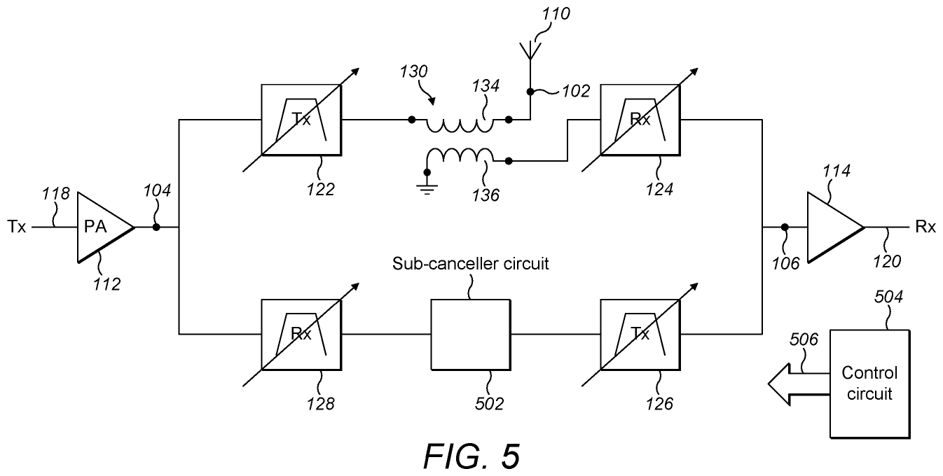

The variable impedance 116 can be tuned to balance the impedance of the antenna connected to the antenna port. As will be discussed with relation to FIG. 5, the series connection as exemplified here by the variable impedance 116 may additionally or alternatively provide cancellation of self-interference.

If the transformer 130 is implemented at the transmit or receive ports, then a series connection may be provided at the opposite one of the receive or transmit ports respectively. For example, at the receive port this may be provides by an appropriately designed LNA 114.

A further variant to the duplexer 100 of FIG. 1, which builds on the variant of FIG. 4, is shown by the duplexer 500 of FIG. 5. Where elements of FIG. 5 are the same as elements in FIG. 1 like reference numerals are used.

Comparing FIG. 5 with FIG. 1, it can be seen that the second transformer 132 is replaced by a sub-canceller circuit 502 being directly connected in series between the second transmit filter 126 and the second receiver filter 128. The impedance port 108 is not shown, as no connection to an external impedance is required.

As with FIG. 4 if the second transformer 132 of the duplexer 100 of FIG. 1 is an ideal transformer, then the duplexers 100 and 500 of FIGS. 1 and 5 are equivalent, as the second transformer 138 of the duplexer 100 FIG. 1 has the effect of transforming the shunt impedance into a series impedance. This series impedance is implemented by the sub-canceller circuit 502.

The sub-canceller circuit 502 of FIG. 5 (and the variable impedance 116 of FIG. 4) is a network in series between the transmit and receive ports. The network in series may include one or more connections to electrical ground within that network, or at either side of the network. One or more connections to electrical ground may be via a component, such as an impedance (which may be variable).

FIG. 5 additionally chows a control circuit 504, generating control signals 506. The control signals 506 control the setting of any element having a variable setting in the duplexer, such as the tuneable filters 122, 124, 126, 128, and the sub-canceller 502, in FIG. 5. In general a control circuit may be connected to any of the exemplary embodiments described for the purpose of tuning the filters to the desired frequency bands and configuring the circuit to provide cancellation of self-interference.

FIG. 5 shows a duplexer comprising a three-port network, the three ports being the transmit port 104, the receive port 106, and the antenna port 102.

Each of the first and second transmit filters 122 and 126 and the first and second receive filters 124 and 128 is preferably tuneable.

In general, for all examples, the transmit port is for connection to a signal to be transmitted by an antenna of the multiplexer, and the receiver port is for connection to a signal receiver by an antenna of the multiplexer, and for providing an output of the multiplexer.

The ports of each of the first and second transmit and receive filters which are connected to either the transmit or receive port are designed to tend toward an open circuit in the stopband. These filter ports are connected directly with another filter via the transmit and receive ports. By this design the filters do not ‘see’ each other. That is in a first filter's passband the second filter is an open circuit (or high impedance) and therefore does not load the port of the first filter. This minimises the interaction of filters which are directly connected.

The ports of each of the first and second transmit and receiver filters which are connected to a transformer winding are designed to tend toward a short circuit in the stopband. In this way the transformer terminal is grounded (or has a low impedance to ground) outside of the passband of that filter. This minimises interaction with the filter connected on the other side of the transformer.

This applies to implementation of the filters in any described arrangement.

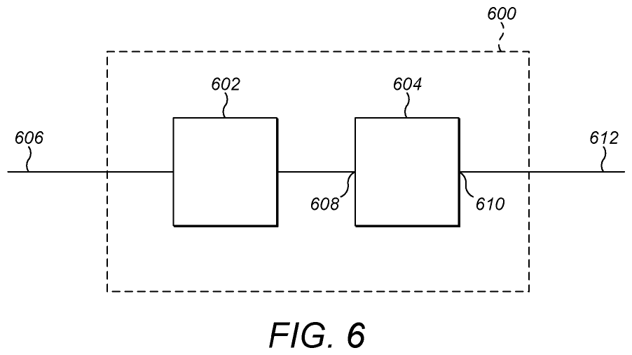

FIG. 6 depicts an exemplary method of achieving preferable input impedance characteristics in the filters used in any of the described arrangements, as set out below.

Each filter is preferably designed to have a matched impedance at one of the transmit and receive frequency bands (according to whether it is a transmit or receive filter). The filter then passes signals at the associated frequency.

The ports of each of the first and second transmit and receive filters which are connected directly to another filter (not shown in FIG. 6) may be designed to provide an impedance higher than the matched impedance in the passband of a filter to which it is directly connected. This is such that interaction between the filters is reduced, as each directly connected filter preferably presents a relatively high impedance in the passband of the other directly connected filter. In this way the port of the filter tends toward an open circuit at some frequencies in the stopband.

The ports of each of the first and second transmit and receive filters which are connected to another filter via a transformer (not shown in FIG. 6) may be designed to provide an impedance lower than the matched impedance in the passband of a filter to which it is connected via the transformer. This is such that interaction between the filters is reduced, as each filter connected to the transformer preferably presents a low impedance to electrical ground in the passband of the other filter connected to the transformer. In this way the port of the filter tends toward a short circuit at some frequencies in the stopband.

The matched impedance of each filter may also be considered a nominal impedance—in general the impedance should be sufficiently well-matched in the frequency band to allow good transfer of power to/from connected circuits.

With reference to FIG. 6. the filter 600 comprises a symmetric filter 604 and an impedance inverter 602. The filter 600 is a two-port network with ports 606 and 612. The symmetric filter 604 is symmetric in the sense that it is a two-port network with the same input impedance characteristics on each of its ports 608 and 610. The symmetric filter may be designed to have a matched input impedance in a passband and a low impedance in a stopband. Many filter designs are well known which can achieve this. The operation of an impedance inverter is to invert the input impedance at the symmetric filter port 608, such that the filter port 606 presents a matched impedance in a passband and a high impedance in a stopband. In contrast the filter port 612 is connected directly to the symmetric filter port 610 without an impedance inverter, and therefore presents the same input impedance as the symmetric filter port 610. In this manner, filters can be designed to provide the preferable input impedance characteristics described above over the frequency ranges of interest, e.g. the transmit and receive frequency bands. Although in practice an ideal impedance inverter cannot be implemented at all frequencies, various non-ideal implementations are well known which can approximate an impedance inverter over a limited frequency range. This may be sufficient to cover the frequency band or bands of interest, e.g. the transmit and receive frequency bands.

The control signals 506 can control the setting of any element having a variable setting in the filter 600.

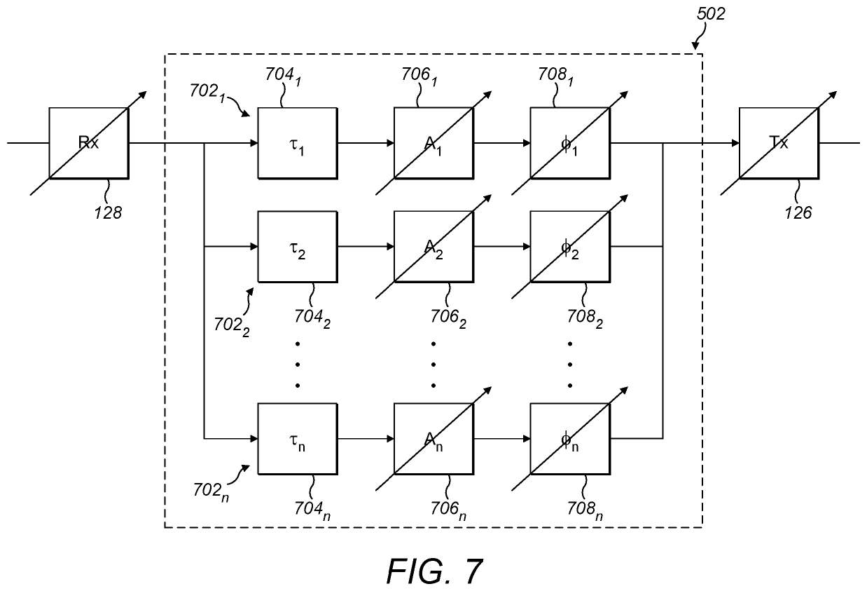

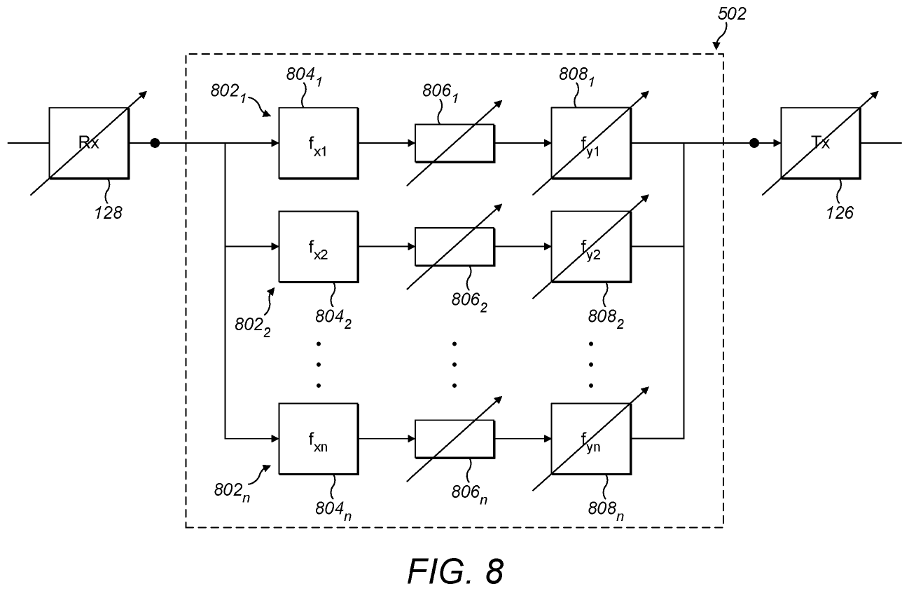

With reference to FIGS. 7 and 8 exemplary implementations of the sub-canceller circuit 502 of FIG. 5 are set out.

The sub-canceller circuit of 502 is provided for one or both of two primary purposes: to provide a balancing impedance for the antenna connected to the antenna port, equivalent to the variable impedance 116, and to provide canceller circuit to cancel self-interference in the duplexer, which may result from a variety of unwanted self-interference coupling mechanisms.

With reference to FIG. 7, a first exemplary sub-canceller circuit 502 is implemented as a multi-tap analogue feed-forward cancellation circuit.

FIG. 7 illustrates an example implementation of a sub-canceller circuit configured to operate in the time domain. As shown in FIG. 7, there are provided n taps or channels in the circuit 502, denoted by reference numerals 702₁ to 702ₙ. Each tap is connected in series between the second receiver filter 128 and the second transmit filter 126.

Each tap 702₁ to 702ₙ includes a respective fixed time delay circuit 704₁ to 704ₙ, tuneable amplitude circuit 706₁ to 706ₙ, and tuneable phase circuit 708₁ to 708ₙ connected in series.

The example sub-canceller 502 of FIG. 7 operates to cancel self-interference in the duplexer in the time domain, with each tap or channel being associated with a specific time delay. For each time delay the signal is attenuated and phase adjusted, so as to minimise the self-interference between the opposite transmit and receive ports.

The control signals 506 can control the setting of any element having a variable setting in the canceller 502 of FIG. 7.

FIG. 8 illustrates an example implementation of a sub-canceller circuit configured to operate in the frequency domain. The sub-canceller circuit 502 of FIG. 8 is implemented as a multi-tap feed-forward cancellation circuit.

As shown in FIG. 8, there are provided n taps or channels in the circuit 502, denoted by reference numerals 802₁ to 802ₙ. Each tap is connected between the second receiver filter 128 and the second transmit filter 126.

Each tap 802₁ to 802ₙ preferably includes a respective filter pair comprising, in series, first tuneable filter circuits 804₁ to 804ₙ, tuneable impedances 806₁ to 806ₙ, and second tuneable filter circuits 808₁ to 808ₙ.

The filter pairs may be tuned to the same frequency, e.g. filter circuits 804₂ to 808₂ may be tuned to the same frequency.

The filters 804 and 808 may be bandpass filters with contiguous but non-overlapping passbands between taps/channels.

The tuneable impedance 806 in each tap may be tuned to adjust the impedance between the terminals of the sub-canceller circuit 502, for each respective tap—i.e. at the frequency of the tap.

Where the filters 804 and 808 have high selectivity this allows the impedances at a particular frequency range to be adjusted independently by adjusting the variable impedance between the filters which have a passband corresponding to a particular frequency range.

The provision of two filters in each tap/channel, either side of the tuneable impedance allows that impedance to be tuned for the frequency of that tap/channel independently. The sub-canceller may be implemented with only one filter in each tap-channel, but in that case the tuneable impedances of all taps/channels may need to be tuned collectively, as the port of one tap-channel filter may ‘see’ all the tuneable impedances of all taps/channel. With a filter either side of the tuneable impedance, the port of one filter can ‘see’ only the one tuneable impedance.

Where the filters 802 and 808 have poor selectivity, or where passbands overlap between taps/channels, then adjusting the impedance at a particular frequency range of interest may require the adjustment of more than one of the variable impedances. This is because at a given frequency of interest, the terminals of the sub-canceller circuit 502 may be coupled to more than one of the variable impedance circuits because the selectivity of the filters may not be adequate to sufficiently attenuate the connections to others of the variable impedance circuits, and more than one tap/channel is therefore active at a particular frequency.

Nonetheless, the use of filters, even with limited selectivity, can enable the aggregate complex impedance of the sub-canceller circuit to be controlled in the frequency domain.

In the preferable arrangement where two filters are provided either side of the tuneable impedance, it is preferable for them to be tuned to the same frequency band. However in some embodiments they may not be tuned to the same frequency bands. For example one filter may be tuned to a frequency range within the transmit frequency band, and one filter may be tuned to a frequency range within the receive frequency band (respectively on the sides of the second receiver filter or second transmit filter, or vice versa).

It is not an essential requirement in the exemplary implementation of FIG. 8 to provide two tuneable filters in each tap. Only one tuneable filter maybe provided in series with a tuneable impedance. Only one tuneable filter may be provided on its own in each tap.

Overall the provision of an impedance, preferably a tuneable impedance, at separate frequencies in a canceller allows cancellation of self-interference to be improved. Cancellation self-interference in the frequency domain rather than time domain simplifies tuning, and allows taps/channel to be optimised individually, rather than together as required in the time domain.

The filters in each tap may be first order filters.

The filters in each tap being tuneable is a preferable feature (whether one or more filters is provided in each tap).

The impedance on each tap being variable is a preferable feature.

The control signals 506 can control the setting of any element having a variable setting in the canceller 502 of FIG. 8.

The canceller circuit examples of FIGS. 7 and 8, including any modification of these examples as discussed, may be implemented as the canceller 502 in FIG. 5.

In an advantageous implementation, where the sub-canceller of FIG. 8 is implemented in the duplexer of FIG. 5, filter symmetry is preferably provided. Filter symmetry is provided by implementing the first transmit and receiver filters 122, 124 as second order filters, and then the second transmit and receiver filters 128, 126, and each of the filters 804,808 in the sub-canceller taps/channels, as first order filters. There is then an equal order of filters between the transmit and receiver ports in the path via the antenna port, and the path via each tap/channel of the sub-canceller circuit. Providing such symmetry is beneficial for achieving cancellation. More generally the order of the transmit filter may be equal to the sum of the order of the further transmit filter and the order of one of the filters in each channel, and the order of the receive filter may be equal to the sum of the order of the further receive filter and the order of one of the further filters in each channel.

In general a sub-canceller circuit such as circuit 502 may be implemented in the three-port network as shown in FIG. 5, but may also be implemented in the four-port network together with connection to an impedance port. The connection to an impedance port, and connection via an impedance to electrical ground, may be made with a network in series between the transmit and receiver ports, with the connection being made at either terminal of the network, or within the network at a connection point.

In the three-port network example, there may be a connection from the network in series 502 to electrical ground.

In general, the series element such as element 502 may be provided on its own or in addition to a balancing impedance connected to electrical ground, and may be provided in the three-port network or the four-port network. A sub-canceller circuit may be implemented in series as is element 502, or implemented in a path to ground via an impedance port.

Various examples and embodiments have been set out as circuits or apparatus. The invention is not limited to circuits or apparatus. The invention may be embodied by methods or processes. Methods or processes may be implemented, at least in part, utilising computer processing techniques. A computer program code may be provided which, when executed on a processor, such as the processor illustrated in examples above, may perform any method or process, at least in part. A computer program product may be provided on which such computer program code is stored.

Various examples and embodiments have been set out to illustrate the invention. Aspects of examples and embodiments may be combined.

The invention has been described by way of reference to various embodiments and implementations. The invention is not limited to the specifics of any example. The scope of protection afforded by the invention is defined by the appended claims.

1. A multiplexer comprising:
a first port for connection to an antenna, and for receiving signals at a transmit frequency and a receive frequency;
a second port comprising first and second terminals;
a third port for receiving a signal to be transmitted, and to connect signals at the transmit frequency to the first port and to connect signals to a terminal of the second port;
a fourth port for receiving a signal received by the antenna, and to connect signals at the receive frequency to the first port and to connect signals to the other terminal of the second port;
a transmit filter connected between the first port and the third port;
a receive filter connected between the first port and the fourth port; and
a cancellation circuit connected between the third and fourth ports, comprising a plurality of parallel channels between the second receive and transmit filters, each channel including a filter.

2. The multiplexer of claim 1 wherein each channel further includes an impedance connected in series with the filter.

3. The multiplexer of claim 1 or claim 2 wherein each channel includes a further filter connected in series with the filter and the further filter, each impedance being connected between the filter and the further filter in that channel.

4. The multiplexer of any one of claims 1 to 3, wherein the passband of each filter is contiguous with the passband of a frequency filter of another channel.

5. The multiplexer of any one of claims 1 to 4, wherein the passband of the filter and further filter in each channel is the same.

6. The multiplexer of any one of claims 1 to 5 wherein each frequency filter is tuneable.

7. The multiplexer of any one of claims 1 to 6 wherein each impedance is tuneable.

8. The multiplexer of any one of claims 1 to 7 further comprising: a further transmit filter connected between the second port and the fourth port, and a further receive filter connected between the second port and the third port.

9. The multiplexer of claim 8 wherein the transmit and receive filters are second order filters, the further transmit and receive filters are first order filters, and the filter in each channel is a second order filter.

10. The multiplexer of claim 8 wherein the order of the transmit filter is equal to the sum of the order of the further transmit filter and the order of one of the filters in each channel, and the order of the receive filter is equal to the sum of the order of the further receive filter and the order of one of the further filters in each channel.

11. A multiplexer comprising:
a first port;
a second port;
a third port connected to the first port and the second port;
a fourth port connected to the first port and the second port; and
a transformer connected at the first port, and having a first winding connected between the first port and one of the third and fourth ports and a second winding connected to the other of the third and fourth ports and electrical ground,
wherein one of the first to fourth ports is for connection to an antenna, the multiplexer further comprising:
a transmit filter connected between the port for connection to the antenna and one of ports to which that port is connected; and
a receive filter connected between the port for connection to the antenna and the other of the ports to which that port is connected.

12. The multiplexer of claim 11, wherein when connected between the same ports, the first or second winding and the transmit or receive filters are connected in series.

13. The multiplexer of claim 11 or claim 12 further comprising:
a further transmit filter connected between the port to which the port for connection to the antenna is not connected and one of the ports to which that port is connected; and
a further receive filter connected between the port to which the port for connection to the antenna is not connected and the other of the ports to which that port is connected.

14. The multiplexer of claim 13, wherein when connected between the same ports, the first or second winding and the first further or second further filter are connected in series.

15. The multiplexer of any one of claims 11 to 14 wherein one of the ports which is not connected to the port which is for connection to the antenna comprises two terminals, the multiplexer further comprising a network in series connected between the two terminals, wherein the other two of the four ports are for connection of the transmit and receive signals of the multiplexer.

16. The multiplexer of claim 15 wherein the first port is for connection to the antenna, the second port comprises two network terminals, the network in series connected between the terminals of the second port, and the third and fourth ports are for connection of the transmit and receive signals of the multiplexer.

17. The multiplexer of claim 15 wherein the first port is for connection of a transmit signal of the multiplexer, the second port is for connection of a receive signal of the multiplexer, the network in series is connected between terminals of the third or fourth ports, and the other of the third or fourth ports is for connection to the antenna.

18. The multiplexer of claim 15 wherein the first port is for connection to a receive signal of the multiplexer, the second port is for connection to a transmit signal of the multiplexer, the network in series is connected between terminals of the third or fourth ports, and the other of the third or fourth ports is for connection to the antenna.

19. The multiplexer of any one of claims 11 to 14 wherein the one of the first to fourth ports which is not connected to the antenna or a port connected to the port which is not connected to the antenna is for connection to an impedance.

20. The multiplexer of claim 19 wherein the first port is for connection to the antenna, the second port is for connection to the impedance, one of the third and fourth ports is a for connection of a transmit signal of the duplexer, and the other of the third and fourth ports is for connection of a receive signal of the duplexer.

21. The multiplexer of claim 19 wherein the first port is for connection of a transmit signal of the duplexer, the second port is for connection of a receive signal of the duplexer, one of the third and fourth ports is for connection to the antenna, and the other of the third and fourth ports is for connection to the impedance.

22. The multiplexer of claim 19 wherein the first port is for connection to an impedance, the second port is for connection to the antenna, one of the third and fourth ports is for connection of a transmit signal of the multiplexer, and the other of the third and fourth ports is for connection of a receiver signal of the multiplexer.

23. The multiplexer of claim 19 wherein the first port is for connection of a receive signal of the duplexer, the second port is for connection of a transmit signal of the duplexer, one of the third and fourth ports is for connection to the antenna, and the other of the third and fourth ports is for connection to the impedance.

24. The multiplexer of any one of claims 19 to 23 wherein the one of the first to fourth ports which is not connected to the antenna or a port connected to the port which is not connected to the antenna comprises two terminals, the multiplexer further comprising a network in series connected between the two terminals.

25. The multiplexer of any one of claims 11 to 14 or 19 to 24 further comprising a further transformer connected at the second port, and having a further first winding connected between the third and fourth ports, and having a further second winding connected between the second port and electrical ground.

26. The multiplexer of claim 25 wherein when connected between the same ports, the further first or further second winding and the transmit or receive filters are connected in series.

27. The multiplexer of claim 25 or claim 26 wherein when connected between the same ports, the further first or further second winding and the further transmit or further receive filters are connected in series.

28. The multiplexer of any one of claims 15 to 18 or 24 wherein the network connected in series between the two terminals is configured to provide cancellation of self-interference in the duplexer.

29. The multiplexer of any one of claims 15 to 18, 24 or 28 wherein the series network comprises a plurality of parallel channels connected between the first and second terminals, each channel including a filter.

30. The multiplexer of claim 29 wherein each channel further includes an impedance connected in series with the filter.

31. The multiplexer of claim 30 wherein each channel includes a further filter connected in series with the filter and the impedance, each impedance being connected between the filter and the further filter in that channel.

32. The multiplexer of any one of claims 29 to 31 wherein the passband of each filter is contiguous with the passband of a filter of another channel.

33. The multiplexer of claim 31 or 32 wherein the passband of the filter and further filter in each channel is the same.

34. The multiplexer of any one of claims 29 to 33 wherein each frequency filter is tuneable.

35. The multiplexer of any one of claims 29 to 34 wherein each impedance is tuneable.

36. The multiplexer of any one of claims 31 to 35 wherein the transmit and receive filters are second order filters, the further transmit and receive filters are first order filters, and the filter in each channel is a first order filter.

37. The multiplexer of any one of claims 10 to 36 wherein each filter has a passband tuned to the frequency of signals to be transmitted between the ports between which the filter is connected, and in this passband each filter presents a matched impedance to these signals.

38. The multiplexer of claim 37 wherein a port of each filter connected to another filter is configured to provide an impedance higher than a matched impedance in the passband of the other filter.

39. The multiplexer of claim 37 or claim 38 wherein a port of each filter connected to a transformer is configured to provide a lower impedance than a matched impedance in the passband of another filter connected to the transformer.
